(19) United States
(12) Patent Application Publication
(10) Pub. No.: US 2024/0082811 A1
(43) Pub. Date: Mar. 14, 2024

(54) Plasma Activated Biochar Filter

(71) Applicants: Board of Trustees of Michigan State University, East Lansing, MI (US); Fraunhofer USA, Plymouth, MI (US)

(72) Inventors: Qi Hua FAN, Okemos, MI (US); Keliang WANG, Okemos, MI (US)

(73) Assignees: Board of Trustees of Michigan State University, East Lansing, MI (US); Fraunhofer USA, Plymouth, MI (US)

(21) Appl. No.: 18/515,730

(22) Filed: Nov. 21, 2023

Related U.S. Application Data
(63) Continuation of application No. PCT/US2022/030672, filed on May 24, 2022.
(60) Provisional application No. 63/193,219, filed on May 26, 2021.

(51) Int. Cl. B01J 20/20; B01D 17/02; B01D 53/02; B01J 20/26; B01J 20/28; B01J 20/30; B01J 20/34; C02F 1/28

(52) U.S. Cl. CPC B01J 20/20; B01D 17/0202; B01D 53/02; B01J 20/262; B01J 20/28004; B01J 20/28045; B01J 20/3085; B01J 20/3416; B01J 20/3491; C02F 1/283; C02F 2101/32

(57) ABSTRACT

A plasma activated biochar filter is provided. In another aspect, Fluorine-based reactive gas is used in a plasma reactor to activate biochar. A further aspect employs a substrate flocked with plasma activated biochar. Yet another aspect employs plasma activated and fluorinated biochar on a porous substrate to act as an oil-fluid separating filter.

### CROSS-REFERENCE TO RELATED APPLICATIONS

The present application claims priority to U.S. provisional patent application Ser. No. 63/193,219, filed on May 26, 2021, which is incorporated by reference herein.

### BACKGROUND AND SUMMARY

This disclosure pertains generally to filter and more particularly to a plasma activated biochar filter.

Petroleum and other oil materials are often in contact with water. This occurs in accidental oil leaks from ships, off-shore oil wells, pipelines and industrial spills. This also intentionally occurs in steam injection to extract petroleum from tar sands. Large-scale conventional oil and water separation techniques typically require complex and expensive machinery, such as centrifuges, evaporators and condensers, which disadvantageously use considerable energy. Such a complex separation system is disclosed in U.S. Pat. No. 10,947,456 entitled “Systems for the Extraction of Bitumen from Oil Sand Material” which issued to Nicosia on Mar. 16, 2021, and is incorporated by reference herein. Other traditional separation systems require expensive and large multi-channel separators with basins, trash racks or bar screens, skimmers, retention baffles, reaction jets, gates and sludge-collection equipment.

It is also known to use biochar for water filtration, and the beneficial properties are enhanced with recent advances in plasma activation of the biochar. For example, plasma activation of biochar material was disclosed in U.S. Pat. No. 9,754,733 entitled “Method for Plasma Activation of Biochar Material,” and U.S. Patent Publication No. 2019/0366298 entitled “Magnetic Field Enhanced Plasma for Materials Processing” both to Q. Fan (one of the co-inventors of the present application). This patent and patent publication are incorporated by reference herein. While these are significant advances in the industry, further improvements are now desirable.

Conventional plasma treatment of biochar, however, employs a static machine within which particles are stationarily retained in a sample holder throughout the plasma treatment process. When the biochar particles pile up, the plasma species disadvantageously interacts primarily with only an exposed top layer and much less so with hidden middle and bottom layers. Thus, static plasma systems have room for improvement when used in mass production where a high volume of particles are processed.

In accordance with the present invention, a plasma activated biochar filter is provided. In another aspect, Fluorine-based reactive gas is used in a plasma reactor to activate biochar. A further aspect employs a substrate flocked with plasma activated biochar. Yet another aspect employs plasma activated and fluorinated biochar on a porous substrate to act as an oil-fluid separating filter. In yet another aspect, a plasma activated biochar and liquid mixture are used as an impact absorber. Methods and apparatuses for making a plasma activated biochar filter are also provided.

The present plasma activated biochar filter is advantageous over prior devices. For example, the present plasma activated biochar filter can more efficiently and effectively filter a higher volume and flow rate of contaminated fluid than can conventional biochar and other devices, especially when the contaminated fluid includes oil and water. Furthermore, the preferred Fluorine-based plasma activation of biochar beneficially provides a low cost and reusable filter. For example, the Fluorine-based plasma activation in combination with a polyurethane substrate synergistically uses the hydrophobic and oleophilic surface properties of the activated biochar, and the porous properties of the foam substrate. The processes for manufacturing the present plasma activated biochar filters advantageously produce a high quantity of filters in a low cost manner. For example, the flocking process beneficially attaches activated biochar in a uniform manner to metallic or other material types and shapes of substrates. Additional advantages and features will be disclosed in the following description and appended claims, taken in conjunction with the accompanying drawings.

### BRIEF DESCRIPTION OF THE DRAWINGS

FIG. 1 is a perspective view showing a plasma activated biochar filter employed in a water pipe;

FIG. 2 is a perspective view showing the plasma activated biochar filter employed in a kitchen fryer;

FIG. 3 is a diagrammatic view showing the plasma activated biochar filter employed in a laboratory hood;

FIG. 4 is a diagrammatic view showing a process for manufacturing the plasma activated biochar filter;

FIG. 5 is a cross-sectional view showing a plasma reactor employed to plasma activate the biochar employed in the filter;

FIG. 6 is a perspective view showing one embodiment machine to manufacture a portion of the plasma activated biochar filter;

FIG. 7 is a perspective view showing another embodiment machine to manufacture a portion of the plasma activated biochar filter;

FIG. 8 is a diagrammatic cross-sectional view, taken along line 8-8 of FIG. 1, showing functionality of the plasma activated biochar filter;

FIG. 9 is a diagrammatic view showing an apparatus for reusing the plasma activated biochar filter; and

FIG. 10 is a diagrammatic view showing an alternate embodiment energy absorbing apparatus using plasma activated biochar.

### DETAILED DESCRIPTION

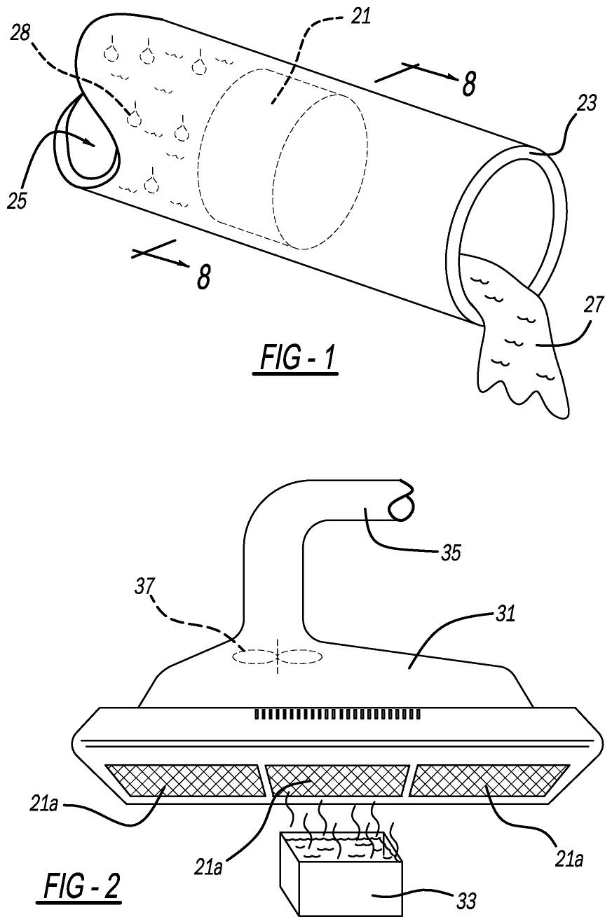

A preferred embodiment of a plasma activated biochar filter 21 within a fluid-carrying pipe 23 is shown in FIG. 1. An incoming oil-contaminated water mixture 25 contacts against biochar filter 21 which functions to block water 28 and allow oil 27 to flow through pipe 23. The term “oil” as used herein includes but is not limited to petroleum hydrocarbons (such as petroleum, mineral oil and hexane), edible cooking oil (natural and synthetic), and the like.

A plasma activated biochar filter 21a is also usable in a kitchen hood 31 as is illustrated in FIG. 2. In this configuration, biochar filter 21a preferably is removably mounted in hood 31. Biochar filter 21a operably separates cooking oil from air as it is pulled from a food fryer 33 into an environmental exit duct 35 of hood 31 via an internal fan 37 which creates a suction. Biochar filter 21a separates and retains the oil contaminant while allowing the clean air to pass therethrough for outside emission.

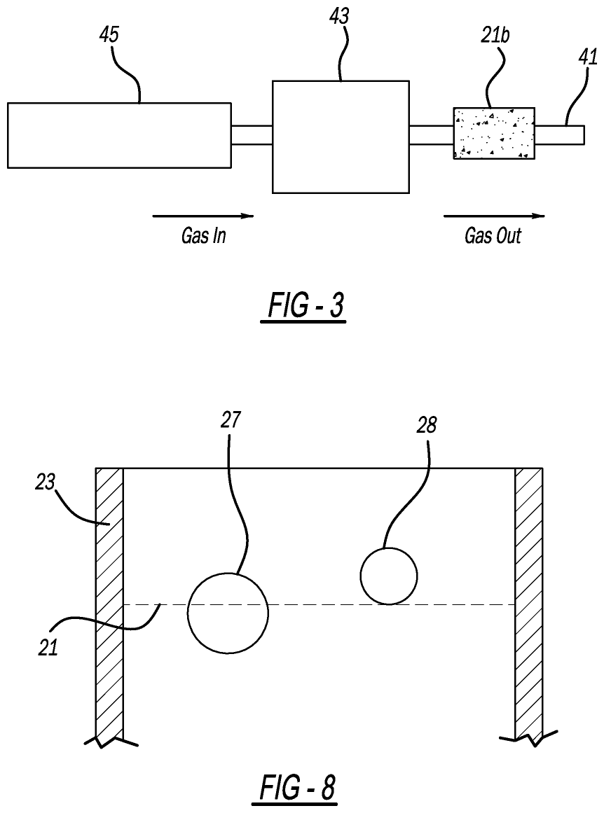

Another use of a plasma activated biochar filter 21b can be observed in FIG. 3. This construction employs biochar filter 21b within an environmental outlet duct 41 which uses a vacuum pump 43 to draw air or other chemical gases within an enclosed vacuum chamber 45. Again, biochar filter 21b separates and retains the oil contaminant while allowing the clean air to pass therethrough for outside emission.

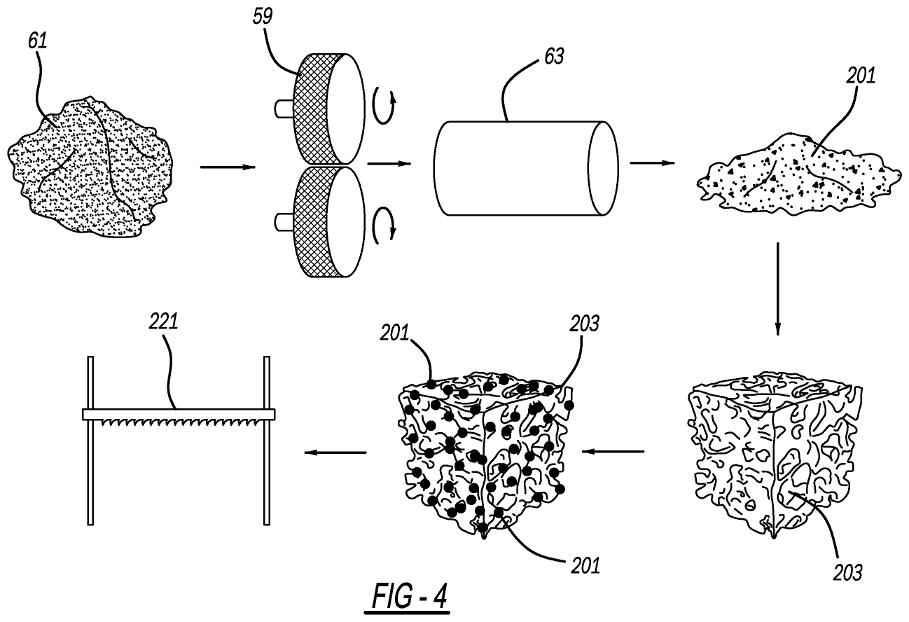

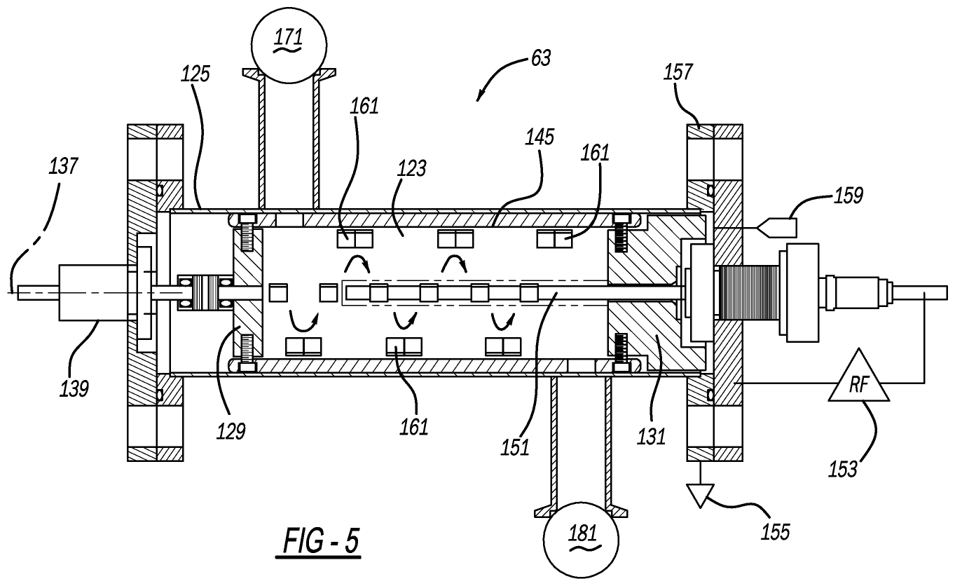

Process and equipment to manufacture plasma activated biochar filters 21, 21a and 21b are shown in FIGS. 4-7. First, biomass is converted into porous biochar 61. Second, a grinder 59 operably grinds the bulky biochar 61 into a powder, with a particle size of about 5-1,000 microns, and more preferably 20-100 microns. Third, biochar powder is then transported to and enters a plasma reactor 63.

Plasma reactor 63 includes a vacuum cavity 123 within a generally horizontally and longitudinally elongated vacuum chamber 125. An end plate 129 and optional insulator cap 131 are fastened inside opposite longitudinal ends of the plasma reactor. Plasma reactor 63 preferably has a casing 145 defined by longitudinally elongated circular-cylindrical inside and outside surfaces, which is rotated about a generally horizontal axis 137 by an electric motor actuator 139. A feeder tank or hopper 171 is connected to an inlet in an upper portion of vacuum chamber 125. A collector tank or hopper 181 is connected to an outlet of vacuum chamber 125.

Moreover, a longitudinally elongated electrode 151 centrally extends from a vacuum flange, through a central hole in insulator cap 131, and internally within plasma reactor 63. A distal end of central electrode 151 is preferably spaced away from end plate 129 so as not to obstruct biochar powder 61 falling down from the inlet aperture and the central electrode is entirely spaced away from the inside surface of casing 145. Notwithstanding, the central electrode longitudinally extends more than a majority of the open longitudinal distance within the plasma reactor which advantageously provides a plasma field along most of the interior area of the reactor.

A radio frequency (“RF”) power source 153 is electrically connected to central electrode 151 and a grounding electrical circuit 155 is connected to a vacuum flange 157, which is in electrical contact with metallic vacuum chamber 125 to serve as a surrounding anode electrode. A matching network is electrically connected between central electrode 151 and RF power source 153 and includes variable capacitors and/or inductor electronics that can be tuned to match plasma impedance with that of the RF power source.

A gas supply cylinder or tank 159 is coupled to an end of vacuum chamber 125 at a port and a vacuum pump is also coupled to a port through the vacuum chamber. A reactive gas or mixture of reactive gases flows from gas tank 159 into the vacuum chamber. Notably, the preferred reactive gas is a Fluorine-based gas such as more than 10% octafluorocyclobutane (C₄F₈) balanced with Ar gas. The Fluorine-based reactive gas advantageously functionalizes biochar powder 201 in plasma reactor 63 for the preferred oil and water, or oil and air separation objective discussed in greater detail hereinafter. Low gas pressures are employed, preferably 10 milliTorr to 20 Torr, more preferably 50 milliTorr to 10 Torr, and even more preferably 50 milliTorr to 3 Torr, by way of non-limiting examples.

Multiple structures 161, such as fins, inwardly project from the inner casing surface. The structures extend in a radial direction generally toward horizontal axis 137, and are longitudinally and circumferentially spaced from each other to create a generally spiraling pattern. A radial gap is between an innermost end of each structure 161 and an outside surface of central electrode 151 to allow the biochar powder to freely fall therebetween with minimal or no obstruction. Structures 161 create a tumbling action while also separating and rotating each powder particle as it falls through the open vacuum space. Therefore, this allows complete exterior surface exposure of each biochar powder particle to the plasma and electromagnetic field on at least one occasion within the reactor. Furthermore, the spiral arrangement of the structures longitudinally transports and moves the biochar powder from the inlet end of reactor 63 to the outlet end of the reactor.

Meanwhile, plasma is generated between the electrodes by the RF electrical field acting upon the reactive gas using an excitation power of at least 50 watts, with a radio frequency of preferably 13.56 MHz. The biochar is preferably activated for less than ten minutes in the reactor. Activated biochar 201 is thereafter obtained from collector hopper 181 for further processing.

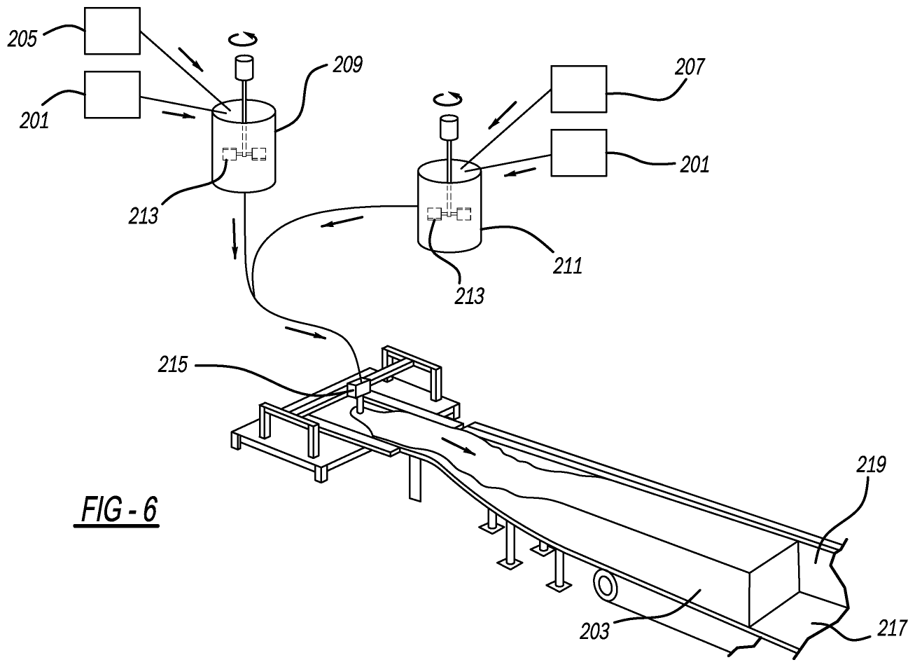

The next steps can be observed by returning to FIGS. 4 and 6, wherein a first embodiment method creates a polyurethane (“PU”) foam substrate 203 by initially mixing activated biochar 201 with at least one of: a di-isocyanate material 205 and/or a polyol material 207, in tanks 209 and 211 each including an electrically powered stirrer 213. The isocyanate and polyol materials subsequently flow to and are injected into a mixing and dispensing head 215. Head 215 emits the mixture onto a continuously moving conveyor bed 217 while the mixture reacts and creates thermosetting polyurethane foam 203. PU foam 203 is preferably made in a continuous slab-stock process while it quickly expands on bed 217 while being laterally constrained by stationary walls 219 (only one of which is shown).

A mechanical saw or laser knife cutter 221 vertically raises and lowers to cut blocks of the foam after full expansion thereof. Activated biochar particles 201 are embedded and loaded within PU foam 203, but leaving open a majority of the pores of the PU foam substrate. The biochar loaded foam filter preferably has a 10-80% porosity ratio of pore volume versus total filter volume, while the biochar surface characteristic is hydrophobic and oleophilic. Furthermore, biochar constitutes 5-80% of the entire PU substrate and activated biochar filter, and more preferably 20-40% of the total filter is the activated biochar, by mass. Oil-fluid separation filters are thereby formed and created from Fluorine-plasma activated biochar, impregnated in a foam substrate.

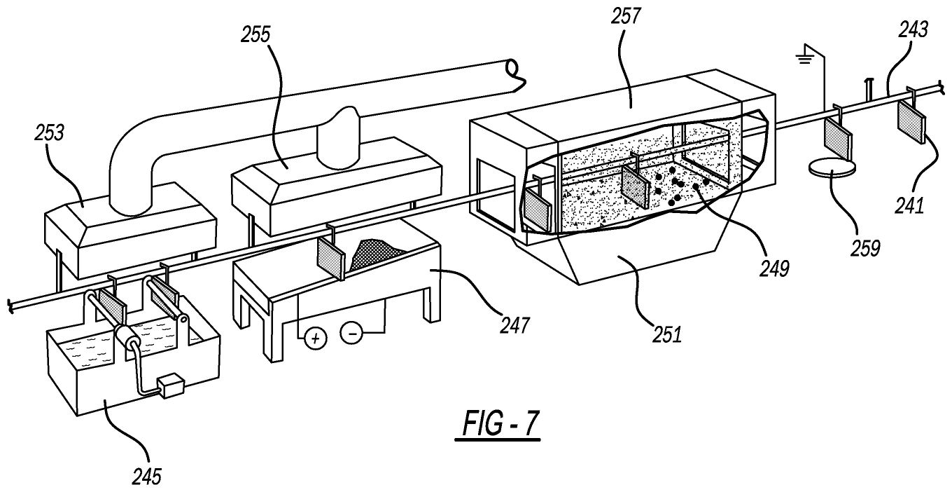

An alternate manufacturing process uses the same Fluorine-plasma reactor to activate biochar 201. However, FIGS. 4 and 7 illustrate subsequent flocking equipment wherein a di-isocyanate material and a polyol material are directly fed to a mixing and dispensing head, but in a substantially pure state without the activated biochar additive. The PU foam reacts and expands as a continuously conveyed slab and is then cut to size to create PU foam substrates 241.

Substrates are subsequently suspended from an overhead conveyor 243 of a flocking apparatus and transported to a vat 245 for the application of an adhesive, such as silicone, onto foam substrate 241. An electrostatic detearing station 247 removes excess adhesive from the suspending hooks and conveyor fixtures. Next, nozzles 249 of a flocking station blow or otherwise emit activated biochar 201 onto the adhesive coated foam substrate 241 with pressurized air.

Hoods 253, 255 and 257, and associated enclosures are part of the adhesive coating, detearing and flocking stations. Finally, a heater 259 heats and dries the adhesive to cure and attach activated biochar particles 201 to the surface of the preformed and cut foam substrate 203. Exemplary flocking equipment is disclosed in U.S. Pat. No. 4,031,270 entitled “Method of Flocking Metal Articles” which issued to Barnes on Jun. 21, 1977; and U.S. Pat. No. 5,263,233 entitled “Method and Apparatus for Flocking an Article and the Article Produced Thereby” which issued to Kim et al. on Nov. 23, 1993; these patents are incorporated by reference herein.

The manufacturing process steps can be summarized as follows:
(a) Grinding the biochar into powder;
(b) Delivering the biochar powder into the plasma reactor;
(c) Pumping down the reactor to a base vacuum less than 50 mTorr;
(d) Flowing Flourine-based reactive gas into the reactor;
(e) Energizing the reactor electrodes to create plasma therein;
(f) Collecting functionalized biochar powder after plasma activation;
(g) Dispersing the activated biochar powder in a solution;
(h) Loading the activated biochar powder onto a substrate carrier, such as a foam, screen or the like;
(i) Shaping and/or cutting the filter to a desired final product size;
(j) Installing the filter in a conduit such as a pipe, hood or the like;
(k) Flowing contaminated fluid, such as oil in water or oil in air, through the filter;
(l) Separating the oil from the water or air; and
(m) Optionally, removing the oil from the filter and reusing the filter.

Alternately, different materials and shapes can be employed for a biochar-flocked substrate. For example, the substrate may be a metal wire mesh or screen. As another example, a porous metallic foam substrate may be flocked or embedded with the activated biochar particles.

The functionality of the filter including the PU foam loaded with Fluorine-activated biochar will now be discussed with reference to FIGS. 4 and 8. The separation of oil and water is aided by the differences in the polarity of the oil and water molecules. The vast majority of molecules present in petroleum are hydrocarbons which are nonpolar due to the relatively low difference in electronegativity between hydrogen and carbon atoms within their molecules. Because of this, they experience only relatively weak London dispersion forces of attraction between molecules. As a result, the free surface energy, or surface tension of oil—a consequence of the attraction between molecules at a surface—is low. Conversely, water is a polar molecule due to the relatively large difference in electronegativity between its oxygen and hydrogen atoms. The hydrogen bonding that occurs between water molecules creates strong attractions between molecules at its surface, resulting in a much higher surface tension than can be found in liquid oil. Furthermore, the comparatively low surface tension and polarity of oil is what causes it to be immiscible in water, allowing many methods to function with minimal consideration for dissolved oils.

Like the oil and water that they aim to separate, the materials used in the present filter have an energy at their surface due to the attractions between each of the material's molecules. If a droplet of liquid comes into contact with a solid material, its behavior will depend on both its surface energy/tension and the surface energy of the material. If the surface tension of a liquid droplet is lower than the surface energy of the material, its molecules will be attracted to the material's surface and the drop will spread. If the surface tension of the liquid is significantly greater than that of the material, the strong attractions within the liquid droplet will prevent it from spreading across the surface. Surfaces with a high surface energy which form contact angles with water below 90 degrees are referred to as hydrophilic, while those with low energy that form contact angles greater than 90 degrees are called hydrophobic; if the liquid exhibiting these interactions is oil, the surface is called oleophilic or oleophobic.

If an already hydrophobic material is given a rough surface, it has the potential to create a larger contact angle with water due to the retention of air pockets in pores between the surface and the water. Likewise, if an already hydrophilic material is given a rough surface, the contact angle of the water may be decreased due to the greater attractive interactions between the water and increased surface area of the rough surface. Surfaces have a surface energy less than that of oil and greater than that of water would have the potential to be both highly hydrophobic and highly oleophilic, which makes them an excellent choice for oil-water separation.

The hydrophilic/oleophobic materials of the present filter 21 are ideally suited for use in oil-water separation. A rough surface and desired surface energy can be induced in the activated biochar material. FIG. 8 shows the behavior of oil 27 and water 28 droplets in contact with a hydrophobic/oleophilic biochar; the water remains suspended or passes through the pores while the oil is attracted by the biochar and is trapped in the filter. The present filter is used to filter oil and water through direct pouring or in crossflow filtration. Additionally, because water settles below oil in gravity systems, hydrophobic/oleophilic filters can be integrated more effectively into gravity systems to purify oily wastewater. This is highly advantageous, as it means they can filter oil and water with less demand for pumps and the energy costs associated therewith. Additionally, due to their small overall size, the present filters can be used in systems with a smaller footprint size than gravity separation tanks. Their function, though it may be dependent on pumps in certain situations, requires less energy input as compared to conventional centrifugal or flotation separators. Moreover, the present separation can be achieved without the need for demulsifiers or coagulants, which reduces costs. Also, the present filter avoids significant fouling in contrast to conventional membrane filters.

Selectively wettable, sorbent materials used in the present apparatus allow for in-situ oil removal since the hydrophobic/oleophilic activated biochar sorb oil and repel water. Through adsorption, in which oil adheres to the surface of a sorbent, or through absorption, in which oil is attracted into the volume of the sorbent's structure, these activated biochar materials are able to retain large volumes of oil while retaining comparatively little water. The Fluorine-activated biochar sorbents with a porous morphology and a lower surface energy than water demonstrate superhydrophobicity. In addition to their surface properties, the Fluorine-activated biochar has three-dimensional porous and microporous structures, which aid in their oil removal. The hydrophobic properties of the activated biochar will overwhelm the hydrophilic properties of the PU substrate.

It is noteworthy that conventional absorption capacity using biochar without plasma activation and fluorination, is less than 5 gₒᵢₗ/gₚᵤ. In comparison, the present C₄F₈ and plasma activated biochar has an absorption capacity of at least 45 gₒᵢₗ/gₚᵤ. More than 95% of the oil will be separated from the water. Therefore, the separation and filtration performance increase is greatly beneficial with the present filter.

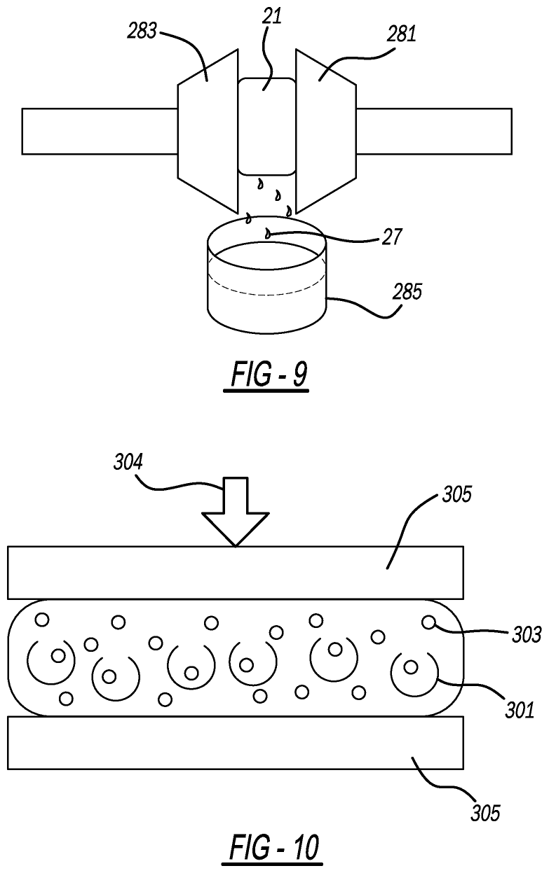

Referring to FIG. 9, after the sorbent biochar of the present filter 21 has absorbed the oil therein, the sorbent and oil must be processed. Preferably, a pair of opposing clamp arms 281, driven by hydraulic cylinder or electromagnetic actuators, squeeze filter 21 to remove oil 27 therefrom for recovery into a receptacle tank 285. Filter 21 is thereafter reusable.

Another embodiment of C₄F₈ and plasma activated biochar 301 is for use as an impact or mechanical shock absorber. This can be observed in FIG. 10. Biochar 301 has a porous structure including internal pores. The hydrophobic surface nature of the activated biochar only allows fluid molecules 303 to enter the porous opening in the biochar particles 301 when a predetermined impact force 304 compresses one external wall 305 toward another, thereby compressing the liquid and suspended biochar matrix therebetween. The liquid molecules 303 will displace or compress air otherwise nominally present in the biochar pores so as to absorb some of the impact force. Walls 305 may be substantially rigid polymeric or metallic shells or plates in helmets, armor, bumpers or the like.

While various embodiments have been disclosed, other variations are possible. For example, the permanent magnets or inductive coil magnets may be mounted to the central electrode in the reactor, although specific benefits may not be achieved. Moreover, the axis and fins of the reactor may differ, but it may not be as advantageous. The shapes, sizes and thicknesses of the substrate and biochar may vary from that disclosed, however, certain performance features may differ. The present filters may have different end uses and may separate alternate materials, such as benzene contaminants from water. It should also be appreciated that the flocked biochar can have other uses that do not serve as filters. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. It is alternately envisioned that the dependent claims are all multiply dependent on each other in some aspects of the present application. The same may also be varied in many ways. Such variations are not to be regarded as a departure from the disclosure, and all such modifications are intended to be included within the scope and spirit of the present invention.

The invention claimed is:

1. A contaminant filter comprising plasma activated and fluorinated biochar on a porous polyurethane substrate, wherein the activated biochar is configured to absorb a contaminant and produce a cleaned fluid from a contaminated fluid mixture.

2. The filter of claim 1, wherein the substrate is cut from an elongated and expanded slab-stock of a thermoset polyurethane foam.

3. The filter of claim 1, wherein the biochar comprises 5-80% of the entire substrate and activated biochar filter, by mass, and hydrophobic/oleophilic properties of the Fluorine-activated biochar overwhelms hydrophilic properties of the polyurethane substrate.

4. The filter of claim 1, wherein the biochar comprises 20-40% of the entire substrate and activated biochar filter, by mass.

5. The filter of claim 1, wherein the contaminant includes oil and the cleaned fluid includes water, and the substrate and the biochar are configured to block water from flowing through pores therein, while the biochar is configured to allow the oil to flow through the pores therein.

6. The filter of claim 1, wherein the biochar is impregnated in the substrate, the substrate being a polymeric, compressible and porous material, with a majority of pores of the substrate being open.

7. The filter of claim 1, wherein the biochar is a flocking on an external surface of the substrate, the substrate being a porous foam material.

8. The filter of claim 1, wherein the biochar and substrate are part of a hood comprising a fan and exit duct.

9. The filter of claim 1, wherein the biochar and substrate are an impact absorber when liquid molecules are compressed into pores of the biochar.

10. The filter of claim 1, wherein the biochar is a powder having a particle size of 20-100 microns, and Fluorine gas in the plasma comprises more than 5% C₄F₈ balanced with Ar gas.

11. A contaminant filter comprising:
a polyurethane foam;
plasma activated biochar embedded within the foam;
the biochar comprising 20-40% of the entire substrate and activated biochar filter, by mass;
the biochar being hydrophobic/oleophilic; and
the polyurethane foam being hydrophilic.

12. The filter of claim 11, wherein the polyurethane foam and the biochar are configured to block water from flowing through pores therein, while the biochar is configured to allow the oil to flow through the pores therein.

13. The filter of claim 11, wherein the biochar and polyurethane foam are part of a hood comprising a fan and exit duct, and the biochar is configured to trap an airborne contaminant in pores of the biochar while allowing cleaned air to flow through the pores in the biochar.

14. The filter of claim 11, wherein the biochar and polyurethane foam are an impact absorber when liquid molecules are compressed into pores of the biochar.

15. The filter of claim 11, wherein the polyurethane foam and the biochar are compressible between filter uses to remove at least some contaminants trapped in the biochar, and the filter is reusable.

16. The filter of claim 11, wherein the biochar includes Fluorine activated biochar, the biochar is hydrophobic and oleophilic, and the polyurethane foam is porous and compressible.

17. A method of using a contaminant filter, the method comprising:
(a) placing the contaminant filter adjacent a conduit through which an oil and liquid mixture flow, the filter comprising a plasma activated and fluorinated biochar attached to a polyurethane foam;
(b) attracting and trapping the liquid in pores of the biochar; and
(c) flowing the oil through the pores in the biochar.

18. The method of claim 17, wherein:
the liquid includes water;
the biochar is hydrophobic and oleophilic; and
the polyurethane foam is porous and compressible.

19. The method of claim 17, further comprising:
compressing at least one of: the biochar and foam, for reuse thereafter;
the biochar being oleophilic; and
the polyurethane foam being porous.

20. The method of claim 17, wherein the biochar has an absorption capacity of at least 45 gₒᵢₗ/gₚᵤ, and more than 95% of the oil will be separated from the fluid which includes water.

21-24. (canceled)
